(19) United States
(12) Patent Application Publication
(10) Pub. No.: US 2013/0307841 A1
(43) Pub. Date: Nov. 21, 2013

(54) DISPLAY DEVICE

(71) Applicant: Nobuhiro Kuwabara, Osaka-shi (JP)

(72) Inventor: Nobuhiro Kuwabara, Osaka-shi (JP)

(73) Assignee: SHARP KABUSHIKI KAISHA, Osaka-shi, Osaka (JP)

(21) Appl. No.: 13/981,539

(22) PCT Filed: Jan. 23, 2012
(86) PCT No.: PCT/JP2012/051309

§ 371 Date: Jul. 24, 2013

(30) Foreign Application Priority Data
Jan. 25, 2011 (JP) 2011-012667

(51) Int. Cl. G09G 5/00

(52) U.S. Cl. CPC G09G 5/001
USPC 345/212; 345/55

(57) ABSTRACT

The present invention provides a display device in which a lateral crosstalk is suppressed with a simple configuration. A display panel includes a change-over switch, an input-end-side TFT, and an output-end-side TFT which are provided in correspondence with an auxiliary capacitance line CSL, and a data signal line drive circuit includes an operational amplifier. The operational amplifier receives a fluctuation auxiliary capacitance signal which is output from an output end of an auxiliary capacitance line via the output-end-side TFT, receives a reference auxiliary capacitance signal to be applied to the auxiliary capacitance line from an auxiliary capacitance line drive circuit via the input-end-side TFT and the change-over switch, generates an output signal to be output to make the voltage of the fluctuation auxiliary capacitance signal equal to the voltage of the reference auxiliary capacitance signal, and applies again the output signal to the auxiliary capacitance line.

### TECHNICAL FIELD

The present invention relates to a display device and, more particularly, to an active matrix-type display device using a switching element such as a thin film transistor.

### BACKGROUND ART

In recent years, an active matrix-type display device such as a liquid crystal display device or an organic EL display device is widely spread. Particularly, a liquid crystal display device in which a switching element such as a thin film transistor (TFT) is provided for each pixel circuit receives attention since it can obtain a display image with suppressed crosstalk even when the number of pixels increases.

Such an active matrix-type liquid crystal display device is conventionally requested to realize lower power consumption. As one of methods of realizing lower power consumption, there is known a method of performing polarity inversion driving by changing the potential of a corresponding auxiliary capacitance line after completion of a selection period of each scanning signal line. In such a driving method, a large voltage can be applied to a liquid crystal layer with small data signal amplitude, so that the power consumption can be reduced. Such a driving method is disclosed in, for example, Patent Documents 1 to 3.

However, in a liquid crystal display device performing polarity inversion driving by changing the potential of an auxiliary capacitance line, an auxiliary capacitance is formed by a pixel electrode and an auxiliary capacitance line, so that a potential fluctuation in a pixel electrode which occurs at the time of writing a data signal to the pixel electrode is transmitted to the auxiliary capacitance line via the auxiliary capacitance. Consequently, the potential in the auxiliary capacitance line fluctuates and, as a result, the pixel potential becomes a value different from the potential to be held originally. Due to this, the conventional liquid crystal display device using the method of performing the polarity inversion driving by changing the potential of a corresponding auxiliary capacitance line after completion of the selection period of each scanning signal line has a problem such that a crosstalk in the lateral direction (hereinbelow, called “lateral crosstalk”) occurs and display quality deteriorates.

As a method of solving such a lateral crosstalk, Patent Document 4 discloses a liquid crystal display device in which each auxiliary capacitance line is provided with a Cs drive circuit configured by a comparison circuit, an output circuit, and a detection circuit. In the liquid crystal display device, the potential of an auxiliary capacitance line is detected by the detection circuit, the potential is compared with a power supply potential of the Cs drive circuit by the comparison circuit and, based on a difference signal of the potentials, a signal for correcting the potential of the auxiliary capacitance line is supplied to the auxiliary capacitance line. Consequently, even in the case where the potential of the auxiliary capacitance line fluctuates, the fluctuation can be suppressed, so that a good image can be displayed. In addition, means for suppressing deterioration in the display quality related to the present invention and the like are disclosed in, for example, Patent Documents 5 to 13.

### PRIOR ART DOCUMENTS

### Patent Documents

[Patent Document 1] Japanese Patent Application Laid-Open No. 2006-220947

[Patent Document 2] Japanese Patent Application Laid-Open No. 2002-196358

[Patent Document 3] Japanese Patent Application Laid-Open No. 2007-47220

[Patent Document 4] Japanese Patent Application Laid-Open No. 2000-98336

[Patent Document 5] Japanese Patent Application Laid-Open No. 2001-147420

[Patent Document 6] Japanese Patent Application Laid-Open No. H04-22923

[Patent Document 7] Japanese Patent Application Laid-Open No. H06-180564

[Patent Document 8] Japanese Patent Application Laid-Open No. H08-36161

[Patent Document 9] Japanese Patent Application Laid-Open No. H11-242205

[Patent Document 10] Japanese Patent Application Laid-Open No. 2006-189473

[Patent Document 11] Japanese Patent Application Laid-Open No. 2008-181053

[Patent Document 12] Japanese Patent Application Laid-Open No. 2009-109924

[Patent Document 13] PCT International Publication No.

### SUMMARY OF THE INVENTION

### Problem to be Solved by the Invention

However, in the configuration of the liquid crystal display device described in the Patent Document 4, a comparison circuit, a detection circuit, and an output circuit are necessary for each auxiliary capacitance line, so that the circuit configuration becomes disadvantageously complicated.

Therefore, an object of the present invention is to provide a display device in which a lateral crosstalk can be suppressed with a simple configuration.

### Solution to the Problems

A first aspect of the present invention relates to a display device including:

a plurality of data signal lines to which a plurality of data signals representing an image to be displayed are applied, respectively;

scanning signal lines crossing the plurality of data signal lines and selectively driven by applying a plurality of scanning signals, respectively;

a plurality of pixel circuits disposed in a matrix in correspondence with respective intersections of the plurality of data signal lines and the plurality of scanning signal lines;

a plurality of auxiliary capacitance lines disposed along the plurality of scanning signal lines, respectively;

an auxiliary capacitance line drive circuit for applying a plurality of auxiliary capacitance signals to the plurality of auxiliary capacitance lines, respectively;

a differential amplifier including a first input terminal, a second input terminal, and an output terminal; and

a plurality of change-over switches provided in correspondence with the plurality of auxiliary capacitance lines, respectively,

wherein each of the change-over switches includes a first switching terminal and a second switching terminal,

each of the pixel circuits includes

a pixel switching element which enters a conduction state when the scanning signal line passing a corresponding intersection is in a selection state and enters a blocking state when the scanning signal line is in a non-selection state,

a pixel electrode connected to a data signal line passing the corresponding intersection via the pixel switching element,

a common electrode provided commonly to the plurality of pixel circuits, and

an auxiliary capacitance formed between the pixel electrode and an auxiliary capacitance line disposed along a scanning signal line passing the corresponding intersection,

after the scanning signal line is switched from a selection state to a non-selection state, the auxiliary capacitance line drive circuit changes a potential of an auxiliary capacitance signal to be applied to an auxiliary capacitance line disposed along the scanning signal line,

the first input terminal and an output end of each of the auxiliary capacitance lines are connected to each other via a plurality of terminating end parts,

an auxiliary capacitance signal to be applied to the auxiliary capacitance line disposed along the scanning signal line which is in the selection state is given to the second input terminal from the auxiliary capacitance line drive circuit,

the output terminal and an input end of each of the auxiliary capacitance lines are connected to each other via the first switching terminal of a corresponding change-over switch,

the auxiliary capacitance line drive circuit and an input end of each of the auxiliary capacitance lines are connected to each other via the second switching terminal of corresponding change-over switch, and

each of the change-over switches is controlled to select the first switching terminal or the second switching terminal in accordance with a predetermined signal.

A second aspect of the present invention is characterized in that, in the first aspect of the present invention, each of the change-over switches is controlled to select the first switching terminal when a scanning signal line along a corresponding auxiliary capacitance line is in a selection state and to select the second switching terminal when the scanning signal line is in a non-selection state.

A third aspect of the present invention is characterized in that, in the second aspect of the present invention, the auxiliary capacitance line drive circuit and the second input terminal are connected to each other via a plurality of input-end-side switching elements provided in correspondence with the plurality of auxiliary capacitance lines,

one of conduction terminals of each of the input-end-side switching elements is connected to the auxiliary capacitance line drive circuit and connected to a corresponding auxiliary capacitance line via the second switching terminal, and

the other conductive terminal of each of the input-end-side switching elements is connected to the second input terminal.

A fourth aspect of the present invention is characterized in that, in the third aspect of the present invention,

a control terminal of each of the input-end-side switching elements is connected to a corresponding scanning signal line, and

each of the input-end-side switching elements enters a conduction state when the corresponding scanning signal line is in the selection state and enters a blocking state when the corresponding scanning signal line is in the non-selection state.

A fifth aspect of the present invention is characterized in that, in the second aspect of the present invention, each of the terminating end parts is an output-end-side switching element.

A sixth aspect of the present invention is characterized in that, in the fifth aspect of the present invention, a control terminal of each of the output-end-side switching elements is connected to a corresponding scanning signal line, and

each of the output-end-side switching elements enters a conduction state when the corresponding scanning signal line is in the selection state and enters a blocking state when the corresponding scanning signal line is in the non-selection state.

A seventh aspect of the present invention is characterized in that, the display device in the second aspect of the present invention further includes a first resistive element,

wherein each of the terminating end parts is a capacitive element, and

to the first input terminal, an auxiliary capacitance signal to be applied to an auxiliary capacitance line disposed along a scanning signal line which is in the selection state is given via the first resistive element, and an auxiliary capacitance signal output from an output end of the auxiliary capacitance line is given via a capacitive element connected to the output end of the auxiliary capacitance line.

An eighth aspect of the present invention is characterized in that, the display device in the seventh aspect of the present invention further includes a second resistive element,

wherein, to the first input terminal, an auxiliary capacitance signal to be applied to an auxiliary capacitance line disposed along a scanning signal line which is in the selection state is given via the first resistive element, and an auxiliary capacitance signal output from an output end of the auxiliary capacitance line is given via a capacitive element and the second resistive element connected to the output end of the auxiliary capacitance line.

A ninth aspect of the present invention is characterized in that, in the second aspect of the present invention,

the auxiliary capacitance line drive circuit and the second input terminal are directly connected to each other and,

to the second input terminal, a signal having the same potential as that of an auxiliary capacitance signal to be applied to an auxiliary capacitance line disposed along a scanning signal line which is in the selection state is given.

### EFFECTS OF THE INVENTION

According to the first aspect of the present invention, the potential of the auxiliary capacitance line is corrected by an output signal from the differential amplifier. Therefore, the time until the potential of the auxiliary capacitance line fluctuated at the time of writing a data signal recovers to the original potential becomes shorter than that in the conventional technique, so that a fluctuation in the pixel potential caused by the potential fluctuation in the auxiliary capacitance line does not occur. It is sufficient to provide one differential amplifier. As a result, a lateral crosstalk can be suppressed with the simple configuration.

According to the second aspect of the present invention, a change-over switch is controlled by the potential of a scanning signal line. Therefore, only the auxiliary capacitance line in which a potential fluctuation occurs is corrected and, further, it is unnecessary to separately use a signal for controlling the change-over switch. Consequently, the lateral crosstalk can be efficiently suppressed with the simple configuration.

According to the third aspect of the present invention, in the case where there are three or more kinds of potentials to be applied to an auxiliary capacitance line, without performing special designing to the auxiliary capacitance line drive circuit, effects similar to those of the second aspect of the present invention can be produced.

According to the fourth aspect of the present invention, since the input-end-side switching element is controlled by the potential of the scanning signal line, it is unnecessary to separately use a signal for controlling the input-end-side switching element. Consequently, effects similar to those of the third aspect of the present invention can be produced with the simpler configuration.

According to the fifth aspect of the present invention, the potential of the auxiliary capacitance line corresponding to a scanning signal line which is in the non-selection state is not influenced by the potential of the auxiliary capacitance line corresponding to a scanning signal line which is in the selection state. Thus, a lateral crosstalk can be suppressed more efficiently.

According to the sixth aspect of the present invention, an output-end-side switching element is controlled by the potential of the scanning signal line, so that it is unnecessary to separately use a signal for controlling the output-end-side switching element. Consequently, effects similar to those of the fifth aspect of the present invention can be produced with the simpler configuration.

According to either the seventh or eighth aspect of the present invention, by using a resistive element and a capacitive element, effects similar to those of the second aspect of the present invention can be produced with the simpler configuration.

According to the ninth aspect of the present invention, by directly connecting the auxiliary capacitance line drive circuit and the second input terminal to each other, effects similar to those of the second aspect of the present invention can be produced with the simpler configuration.

### BRIEF DESCRIPTION OF THE DRAWINGS

FIG. 1 is a circuit diagram illustrating an electrical configuration of a liquid crystal display device according to a first embodiment of the present invention.

FIG. 2 is a diagram illustrating a layout of a chip pad and an example of connection of wires in the first embodiment.

FIG. 3 is a diagram illustrating a layout of a chip pad and an example of connection of wires in the first embodiment.

FIGS. 4(A) to 4(D) are voltage waveform charts for explaining operation of a liquid crystal display device according to the first embodiment.

FIG. 5 is a diagram illustrating an example of displaying a predetermined display pattern in the first embodiment.

FIGS. 6(A) to 6(D) are voltage waveform charts of parts corresponding to a scanning signal line GL(n) and an auxiliary capacitance line CSL(n) in the display image illustrated in FIG. 5.

FIGS. 7(A) to 7(D) are voltage waveform charts of parts corresponding to a scanning signal line GL(p) and an auxiliary capacitance line CSL(p) in the display image illustrated in FIG. 5.

FIG. 8 is a circuit diagram illustrating an electrical configuration of a liquid crystal display device according to a second embodiment of the present invention.

FIG. 9 is a circuit diagram illustrating an electrical configuration of a liquid crystal display device according to a third embodiment of the present invention.

FIG. 10 is a circuit diagram illustrating an electrical configuration of a liquid crystal display device related to a basic examination of the present invention.

FIG. 11 is a circuit diagram illustrating an electrical configuration of a pixel circuit in the basic examination and the first embodiment.

FIGS. 12(A) to 12(E) are voltage waveform charts for explaining operation of the liquid crystal display device in the basic examination and the first embodiment.

FIG. 13 is an equivalent circuit diagram of an auxiliary capacitance line.

FIGS. 14(A) and 14(B) are voltage waveform charts of a case where recovery time is shorter than a write period; and FIG. 14(A) is a voltage waveform chart of the potential of an auxiliary capacitance line resulting from enlarging a part RA surrounded by the broken line in FIG. 12(C) and FIG. 14(B) is a voltage waveform chart of the pixel potential resulting from enlarging a part RB surrounded by the broken line in FIG. 12(E).

FIGS. 15(A) and 15(B) are voltage waveform charts of a case where recovery time is longer than a write period, and FIG. 15(A) is a voltage waveform chart of the potential of the auxiliary capacitance line resulting from enlarging the part RA surrounded by the broken line in FIG. 12(C) and FIG. 15(B) is a voltage waveform chart of the pixel potential resulting from enlarging the part RB surrounded by the broken line in FIG. 12(E).

FIGS. 16(A) to 16(D) are voltage waveform charts for explaining the operation of the liquid crystal display device related to the basic examination according to the magnitude of a potential fluctuation amount ΔV.

FIG. 17 is a diagram illustrating an example of displaying a predetermined display pattern in the liquid crystal display device relate to the basic examination.

FIGS. 18(A) to 18(D) are voltage waveform charts of parts corresponding to the scanning signal line GL(n) and the auxiliary capacitance line CSL(n) in the display image illustrated in FIG. 17.

FIGS. 19(A) to 19(D) are voltage waveform charts of parts corresponding to the scanning signal line GL(p) and the auxiliary capacitance line CSL(p) in the display image illustrated in FIG. 17.

### MODES FOR CARRYING OUT THE INVENTION

<0.Basic Examination>

Prior to explanation of embodiments of the present invention, a basic examination made by the present inventors to solve the problem will be described.

<0.1 Configuration of Conventional Liquid Crystal Display Device>

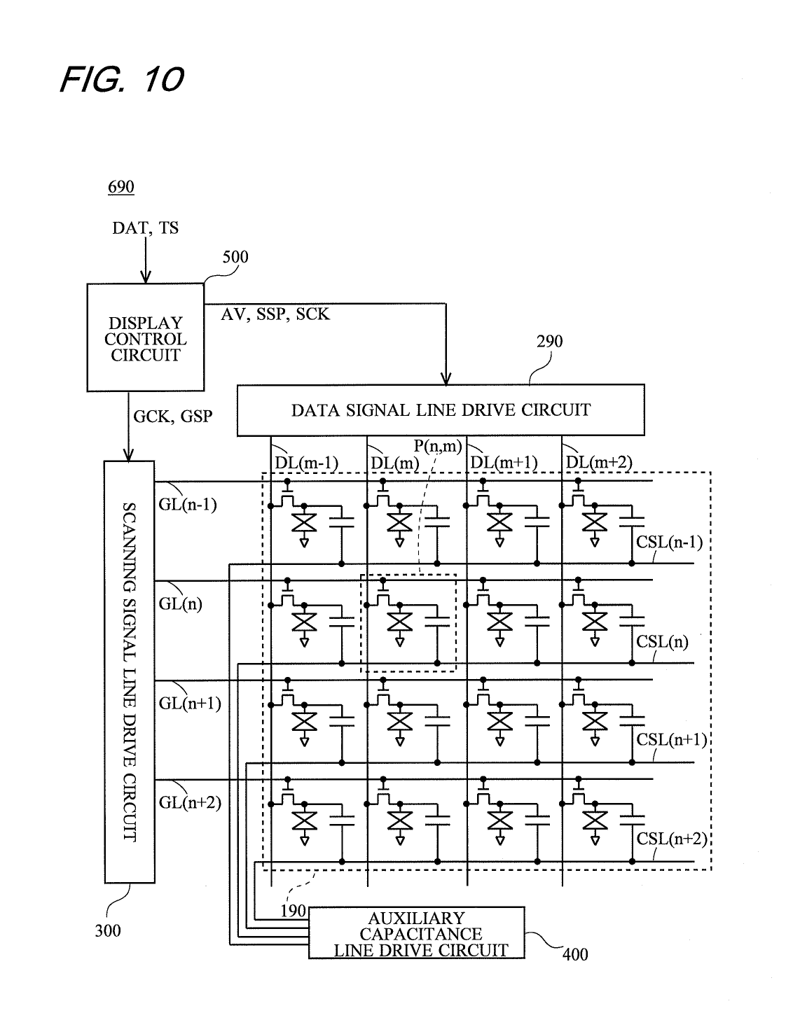

FIG. 10 is a circuit diagram illustrating an electrical configuration of a conventional liquid crystal display device in which polarity inversion drive is performed by changing a potential of a corresponding auxiliary capacitance line after completion of a selection period of each scanning signal line. As illustrated in FIG. 10, a conventional liquid crystal display device 690 has a display panel 190, a data signal line drive circuit 290, a scanning signal line drive circuit 300, an auxiliary capacitance line drive circuit 400, and a display control circuit 500.

The display panel 190 is made by a pair of electrode substrates sandwiching a liquid crystal layer, and a polarizing plate is adhered to the outer surface of each of the electrode substrates. One of the pair of electrode substrates is an active matrix-type substrate called a TFT (Thin Film Transistor) substrate. In the TFT substrate, a plurality of data signal lines DL(1) to DL(M) (hereinbelow, called “data signal lines DL” when they are not distinguished from one another) and a plurality of scanning signal lines GL(1) to GL(N) are formed in a lattice so as to cross each other on an insulating substrate such as a glass substrate and, further, a plurality of auxiliary capacitance lines CSL(1) to CSL(N) (hereinbelow, called “auxiliary capacitance lines CSL” when they are not distinguished from one another) which are respectively disposed along the plurality of scanning signal lines GL(1) to GL(N) (hereinbelow, called “scanning signal lines GL” when they are not distinguished from one another) and can be driven independently of one another are formed. A plurality of pixel circuits P(n, m) are formed in a matrix in correspondence with respective intersections of the plurality of data signal lines DL(1) to DL(M) and the plurality of scanning signal lines GL(1) to GL(N) (n=1 to N, and m=1 to M). Although only 16 pixel circuits are illustrated in FIG. 10 for convenience of the illustration, in reality, N×M pieces of pixel circuits are formed in the display panel 190. The other electrode substrate in the pair is called an opposed substrate in which an opposed electrode and an orientation film are sequentially stacked on an entire insulating substrate such as glass. The plurality of data signal lines DL(1) to DL(M), the plurality of scanning signal lines GL(1) to GL(N), and the plurality of auxiliary capacitance lines CSL(1) to CSL(N) are driven by the data signal line drive circuit 290, the scanning signal line drive circuit 300, and the auxiliary capacitance line drive circuit 400, respectively.

FIG. 11 is a circuit diagram illustrating an electrical configuration of the pixel circuit P(n, m). Each pixel circuit P(n, m) is provided in correspondence with any one of intersections of the plurality of data signal lines DL(1) to DL(M) and the plurality of scanning signal lines GL(1) to GL(N). Each pixel circuit P(n, m) includes a pixel TFT 101 whose source electrode is connected to the data signal line DL(m) passing a corresponding intersection and whose gate electrode is connected to the scanning signal line GL(n) passing the corresponding intersection and a pixel electrode connected to the drain electrode of the pixel TFT 101. A liquid crystal capacitance Clc is formed by the pixel electrode and the opposed electrode, and an auxiliary capacitance Ccs is formed by the pixel electrode and the auxiliary capacitance line CSL(n).

The display control circuit 500 receives display data DAT and a timing control signal TS from the outside and outputs, as signals for displaying an image represented by the display data DAT on the display panel 190, an analog image signal AV, a data start pulse signal SSP, a data clock signal SCK, a gate start pulse signal GSP, and a gate clock signal GCK.

The data signal line drive circuit 290 receives the analog image signal AV, the data start pulse signal SSP, and the data clock signal SCK which are output from the display control circuit 500 and sequentially applies the analog image signal AV to the data signal lines DL based on the data start pulse signal SSP and the data clock signal SCK. In such a manner, the data signal line drive circuit 290 performs driving by a so-called dot-sequential driving method. The present invention is not limited to the dot-sequential driving method.

The data signal line drive circuit 290 may perform driving by a so-called SSD (Source Shared Driving) method as a method of grouping the plurality of data signal lines DL to groups each made of predetermined number of data signal lines DL and driving each of the groups by time-sharing predetermined number of data signals corresponding to each of the groups by an output buffer common to the predetermined number of data signal lines DL. In this case, the data signal line drive circuit 290 receives a digital image signal DV in place of the analog image signal AV, serial-parallel converts the digital image signal DV, and performs digital-to-analog conversion to thereby generate a data signal.

The scanning signal line drive circuit 300 sequentially selects the plurality of scanning signal lines GL(1) to GL(N) every horizontal scanning period in each of frame periods (vertical scanning periods) for displaying a display image on the display panel 190 and applies an active scanning signal (voltage to set the pixel TFT 101 included in the pixel circuit into a conductive state) to the selected scanning signal line.

The auxiliary capacitance line drive circuit 400 applies an auxiliary capacitance signal (predetermined low potential VL or predetermined high potential VH) as a bias of a voltage to be applied to a liquid crystal layer of the display panel 190 independently to the plurality of auxiliary capacitance lines CSL(1) to CSL(N). Note that, the potentials to be applied to the auxiliary capacitance lines are not limited to the two kinds of the low potential VL and the high potential VH. Potentials of three or more kinds may be used.

To the opposed electrode, a potential Vcom as a reference of the voltage to be applied to the liquid crystal layer of the display panel 190 is provided by a not-illustrated opposed electrode drive circuit.

As described above, a plurality of data signals are respectively applied to the plurality of data signal lines DL(1) to DL(M) and a plurality of scanning signals are respectively applied to the plurality of scanning signal lines GL(1) to GL(N), so that a voltage according to a pixel value of a pixel to be displayed using the opposed electrode potential Vcom as a reference is provided to the pixel electrode in each of the pixel circuits in the display panel 190 via the pixel TFT 101 and is held in the pixel capacitance made by the liquid crystal capacitance Clc and the auxiliary capacitance Ccs in the pixel circuit. Consequently, a voltage corresponding to the potential difference between each of the pixel electrodes and the opposed electrode is applied to the liquid crystal layer. By controlling the optical transmittance of the liquid crystal layer by the applied voltage, the display panel 190 displays an image represented by the display data DAT.

<0.2 Operation of Conventional Liquid Crystal Display Device>

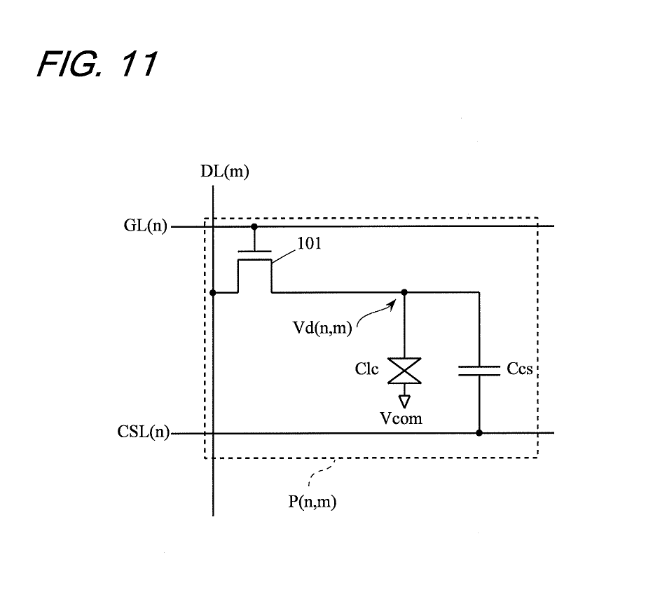

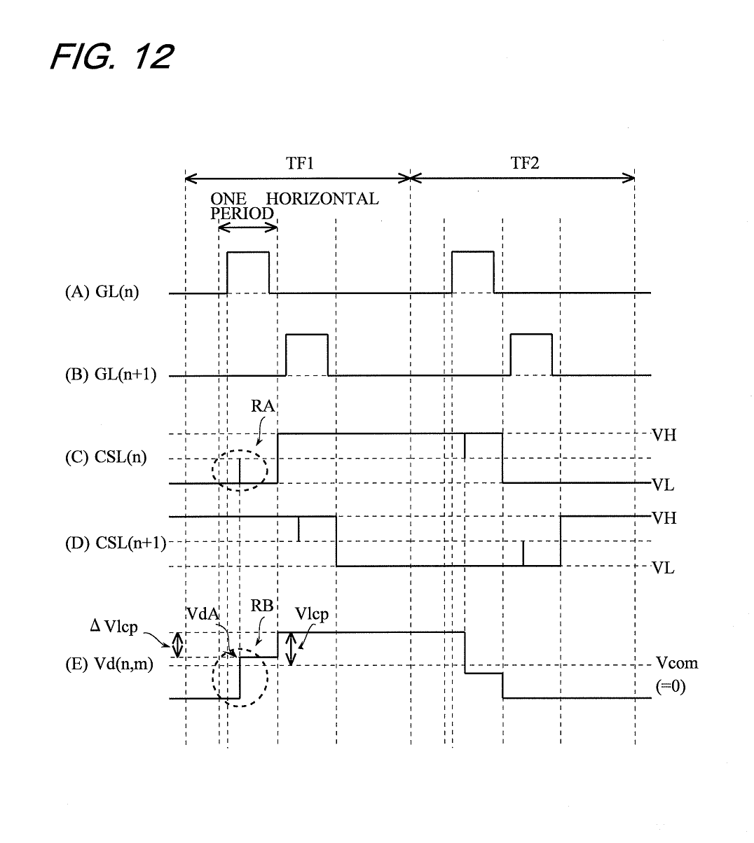

FIGS. 12(A) to 12(E) are diagrams illustrating the voltage waveform of the potential of the scanning signal line GL(n), the potential of the scanning signal line GL(n+1), the potential of the auxiliary capacitance line CSL(n), the potential of the auxiliary capacitance line CSL(n+1), and the potential Vd(n, m) of the pixel electrode (hereinbelow, called “pixel potential”), respectively, in a first frame period TF1 and a second frame period TF2 as successive two frame periods. Here, a description will be given of, by way of example, a case of employing a 1H inversion driving method of performing driving while inverting the polarity using the opposed electrode potential Vcom of a data signal to be applied to the data signal lines DL(1) to DL(m) as a reference every horizontal period and displaying an image in a normally black mode. Although Vcom is set to zero, the present invention is not limited to the value.

In the first frame period TF1, when the scanning signal line GL(n) enters a selection state (FIG. 12(A)), the pixel TFTs 101 in the pixel circuits P(n, 1) to P(n, M) connected to the scanning signal line GL(n) become conductive. In a period of writing the pixel circuit P(n, m), a positive potential VdA as a data signal is provided from the data signal line DL(m) to the pixel electrode, and pixel capacitance is charged. As a result, a pixel potential Vd(n, m) is held at VdA (FIG. 12(E)). Subsequently, when the scanning signal line GL(n) enters a non-selection state and the pixel TFTs 101 connected to the scanning signal line GL(n) are blocked, the charges accumulated in the pixel capacitance are held as they are. During the period, the potential of the auxiliary capacitance line CSL(n) is a predetermined low potential VL. After that, the potential of the auxiliary capacitance line CSL(n) changes to a predetermined high potential VH. After that, in a period until the next frame, the high potential VH is provided to the auxiliary capacitance line CSL(n), and a bias voltage ΔVlcP is added to the pixel potential Vd(n, m). As a result, the voltage V1cP illustrated in FIG. 12(E) is applied to a part sandwiched by the pixel electrode and the opposed electrode in the liquid crystal layer, and charges are held for a period until the pixel TFT 101 becomes conductive again. In the second frame period TF2 as the next frame, operation similar to that in the first frame period TF1 is performed (except that the polarity is inverted). By such operation, large voltage can be applied to the liquid crystal layer with small data signal amplitude, so that power consumption can be reduced.

<0.3 Consideration>

However, since the auxiliary capacitance Ccs is formed by the pixel electrode and the auxiliary capacitance line CSL(n) as described above, a potential fluctuation in the pixel potential Vd(n, m) which occurs at the time of writing the data signal to the pixel electrode is transmitted to the auxiliary capacitance line CSL(n) via the auxiliary capacitance Ccs. The amount ΔV of the potential fluctuation in the auxiliary capacitance line CSL(n) which occurs at this time (hereinbelow, also called “potential fluctuation ΔV”) is approximately expressed by the following equation (1).

ΔV=Vdpre(n, m)−Vdat (1)

where Vdpre(n, m) expresses a pixel potential decided by changing the potential of the auxiliary capacitance line CSL(n) after completion of the selection period of the scanning signal line GL(n) in a previous frame, and Vdat expresses voltage of a data signal to be written in the following frame.

As illustrated in FIG. 12(C), in the auxiliary capacitance line CSL(n), when the polarity of the pixel potential Vd(n, m) changes from negative to positive and changes from positive to negative, the potential fluctuation ΔV occurs (indicated by a straight line in the figure). Similarly, as illustrated in FIG. 12(D), also in the auxiliary capacitance line CSL(n+1), when the polarity of the pixel potential Vd(n+1, m) changes (not illustrated), the potential fluctuation ΔV occurs (indicated by a straight line in the figure). For example, in reality, the auxiliary capacitance line CSL(n) is also influenced by the potential fluctuation in the pixel potentials Vd(n, 1) to Vd(n, m−1) and Vd(n, m+1) to Vd(n, M). However, its illustration and description are omitted for convenience. Also, when the pixel TFT 101 becomes conductive when the scanning signal line GL(n) enters a selection state, the pixel potential Vd(n, m) fluctuates also by the influence of parasitic capacitance in the data signal lines DL(1) to DL(M). However, its illustration and description are omitted for convenience.

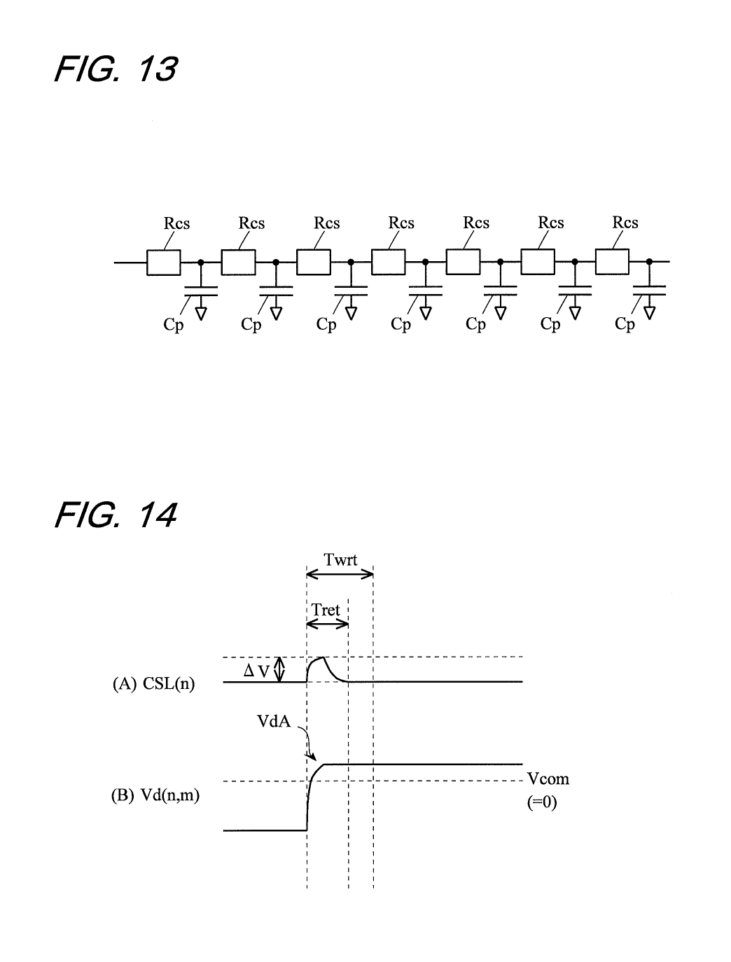

As illustrated in FIG. 13, the auxiliary capacitance line CSL(n) can be expressed by an equivalent circuit made by a wiring resistor Rcs and a parasitic capacitance Cp. The auxiliary capacitance line CSL(n) in which the potential fluctuation ΔV occurs tries to return to the initial potential by charging/discharging the charges held in the parasitic capacitance Cp. In the specification, time since a time point when the potential fluctuation ΔV occurs in the auxiliary capacitance line CSL(n) until a time point when the potential difference between the potential of the auxiliary capacitance line CSL(n) in which the potential fluctuation ΔV occurs and the initial potential becomes a predetermined small potential difference Δε (almost equal to 0 V) is called “recovery time Tret”. The recovery time Tret depends on the resistance value of the wiring resistor Rcs, the capacitance value of the parasitic capacitance Cp, and the potential fluctuation amount ΔV. That is, when the potential fluctuation amount ΔV is considered to be constant, the larger the time constant determined by the resistance value of the wiring resistor Rcs and the capacitance value of the parasitic capacitance Cp is, the longer the recovery time Tret becomes. As described above, to switch the potential of the auxiliary capacitance line CSL(n) between the low potential VL and the high potential VH, a selection switch is necessary for the auxiliary capacitance line drive circuit 400, so that the impedance of the auxiliary capacitance line CSL(n) seen from the auxiliary capacitance line drive circuit 400 further rises. Due to this, particularly, the time constant becomes larger and the recovery time Tret becomes longer by the method of performing polarity inversion driving by changing the potential of the corresponding auxiliary capacitance line after completion of the selection period of each scanning signal line.

FIGS. 14(A) and 14(B) are voltage waveform charts, in the case where Twrt>Tret, of the potential of the auxiliary capacitance line CSL(n) resulting from enlarging a part RA surrounded by the broken line in FIG. 12(C) and the pixel potential Vd(n, m) resulting from enlarging a part RB surrounded by the broken line in FIG. 12(E), respectively. Here, Twrt expresses the period of writing the pixel potential Vd(n, m). In the waveforms illustrated in FIGS. 14(A) and 14(B), the potential of the auxiliary capacitance line CSL(n) recovers within the write period Twrt of the pixel potential Vd(n, m). In this case, the pixel potential Vd(n, m) is not influenced by the potential fluctuation in the auxiliary capacitance line CSL(n).

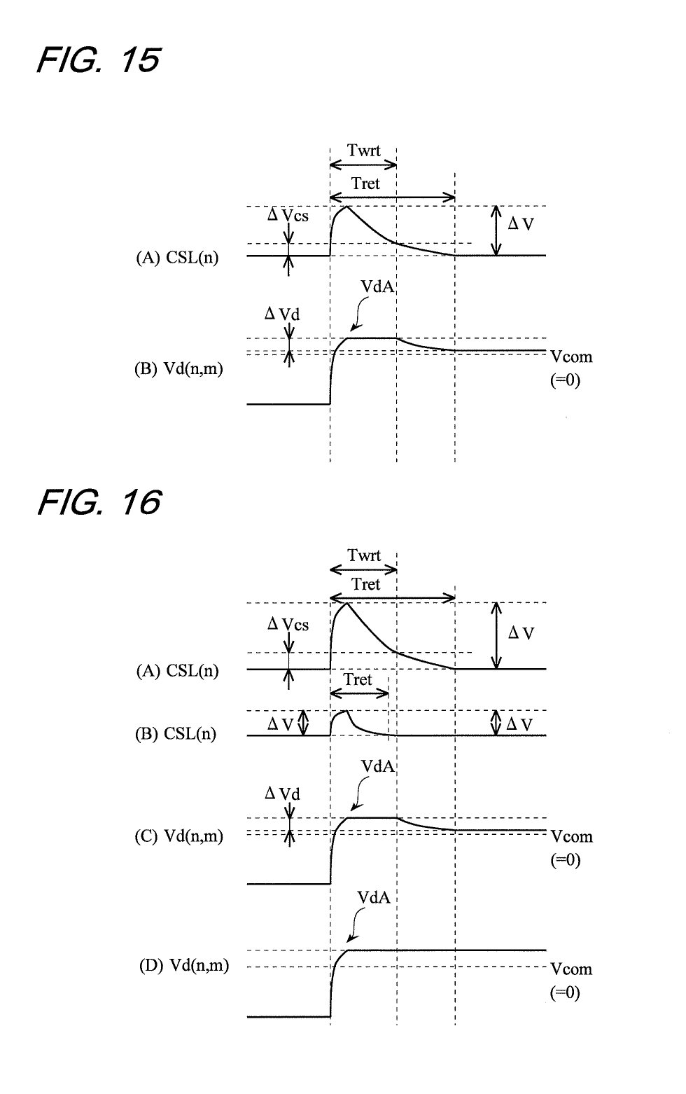

FIGS. 15(A) and 15(B) are voltage waveform charts, in the case where Twrt<Tret, of the potential of the auxiliary capacitance line CSL(n) resulting from enlarging the part RA surrounded by the broken line in FIG. 12(C) and the pixel potential Vd(n, m) resulting from enlarging the part RB surrounded by the broken line in FIG. 12(E), respectively. In the waveforms illustrated in the pixel potential diagrams 15(A) and 15(B), the potential of the auxiliary capacitance line CSL(n) does not recover within the write period Twrt of the pixel potential Vd(n, m). In this case, the pixel potential Vd(n, m) fluctuates only by a fluctuation amount ΔVd (ΔVd<ΔVcs) proportional to a residual voltage ΔVcs as the difference between the potential of the auxiliary capacitance line CSL(n) at the end time point of the write period Twrt and the potential of the original auxiliary capacitance line CSL(n). That is, the pixel potential Vd(n, m) becomes VdA−ΔVd which is the value different from the potential VdA to be held originally. It causes a lateral crosstalk.

When the resistance value of the wiring resistor Rcs and the capacitance value of the parasitic capacitance Cp are considered to be constant, whether the pixel potential Vd(n, m) is influenced or not is determined by the magnitude of the potential fluctuation amount ΔV in the auxiliary capacitance line CSL(n). FIGS. 16(A) and 16(C) are voltage waveform charts resulting from enlarging the parts RA and RB surrounded by the broken line in FIG. 12, respectively (in the case where the potential fluctuation amount ΔV is large). On the other hand, FIGS. 16(B) and 16(D) are voltage waveform charts resulting from enlarging the parts RA and RB surrounded by the broken line in FIG. 12, respectively (in the case where the voltage fluctuation amount ΔV is small). In the case where the potential fluctuation amount ΔV is small, Twrt>Tret is satisfied, so that the pixel potential Vd(n, m) is hardly influenced by the potential fluctuation amount ΔV (FIGS. 16(B) and 16(D)). On the other hand, in the case where the potential fluctuation amount ΔV is large, Twrt<Tret is satisfied and the residual voltage ΔVcs is generated, so that the pixel potential Vd(n, m) becomes a value different from the potential VdA to be held originally. It causes a lateral crosstalk as described above.

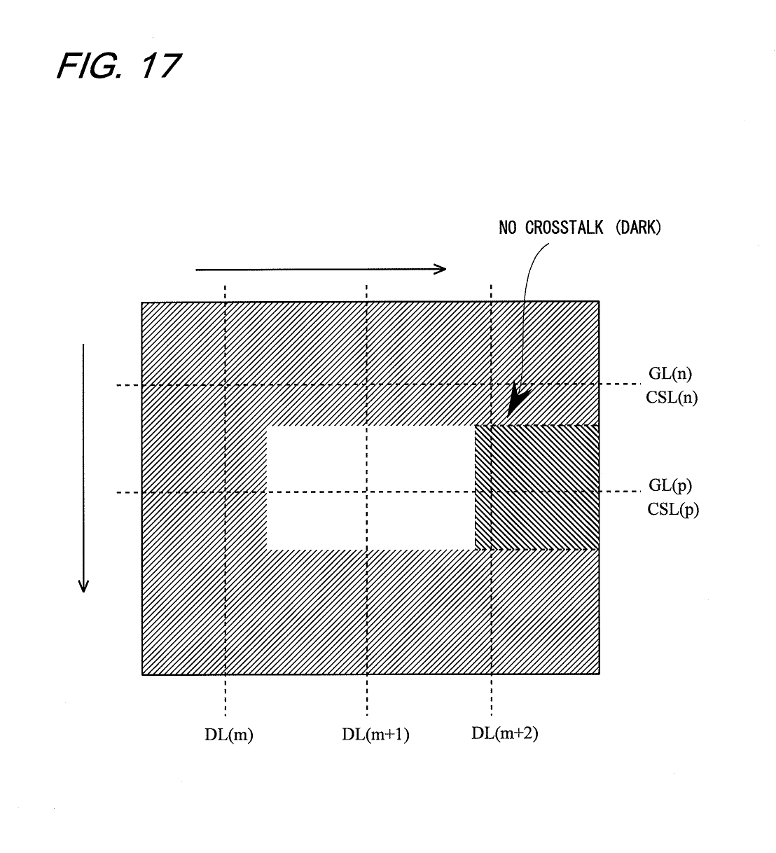

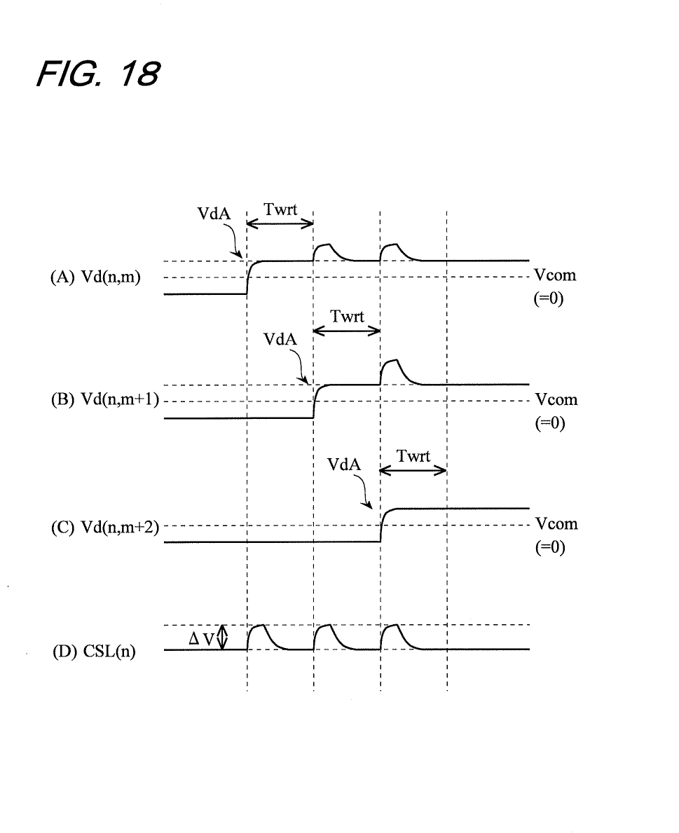

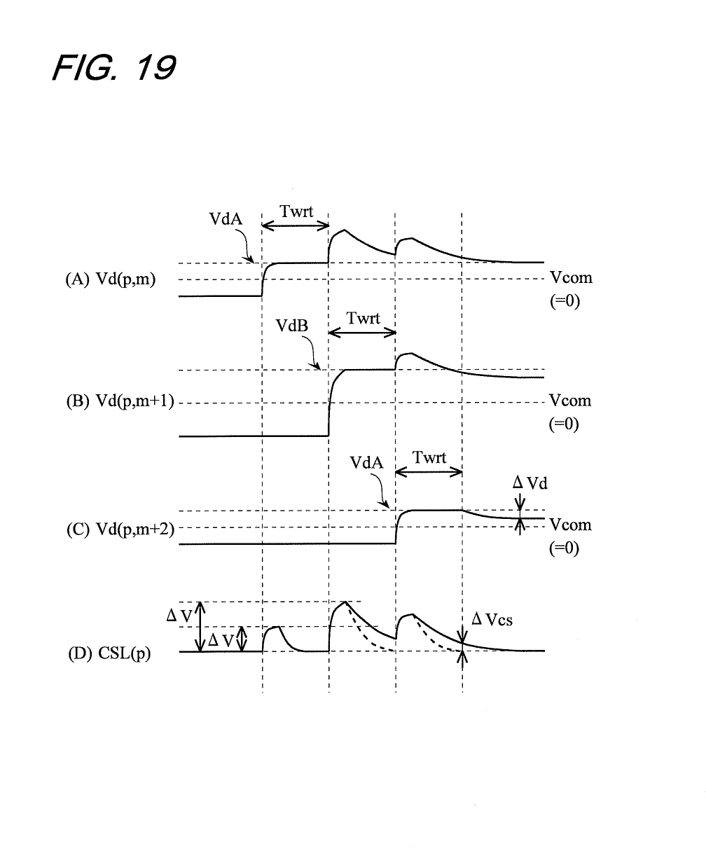

The above-described influence by the residual voltage ΔVcs on the pixel potential Vd(n, m) becomes conspicuous particularly in a display pattern made by a gray background part and a white center part as illustrated in FIG. 17. In FIG. 17, the gray background part is expressed by hatching of thin lines and a dark part which will be described later is expressed by hatching of thick lines. In FIG. 17, for convenience of explanation, the sizes of pixels are non-uniform. The downward arrow and the rightward arrow in FIG. 17 indicate a vertical scanning direction and a horizontal scanning direction, respectively, in image display. All of pixels corresponding to the scanning signal line GL(n) and the auxiliary capacitance line CSL(n) are gray and no display unevenness occurs. On the other hand, pixels corresponding to the scanning signal line GL(p) and the auxiliary capacitance line CSL(p) are gray or white. Pixels corresponding to the data signal line DL(m+2) are supposed to be gray but, due to occurrence of lateral crosstalk, are dark. The lateral crosstalk will now be described more specifically with reference to FIG. 17, FIGS. 18(A) to 18(D), and FIGS. 19(A) to 19(D).

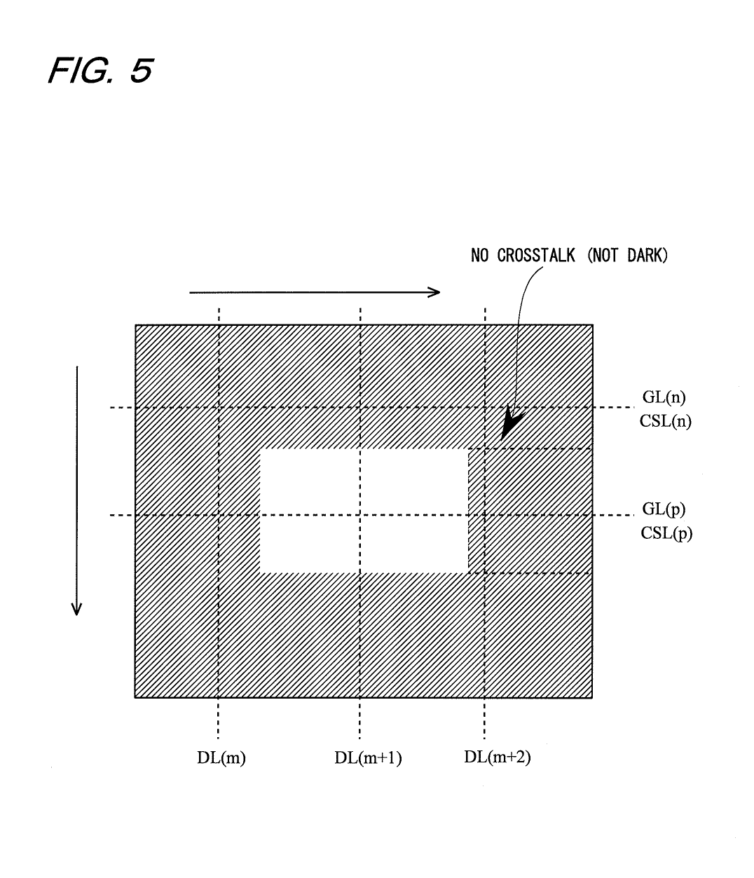

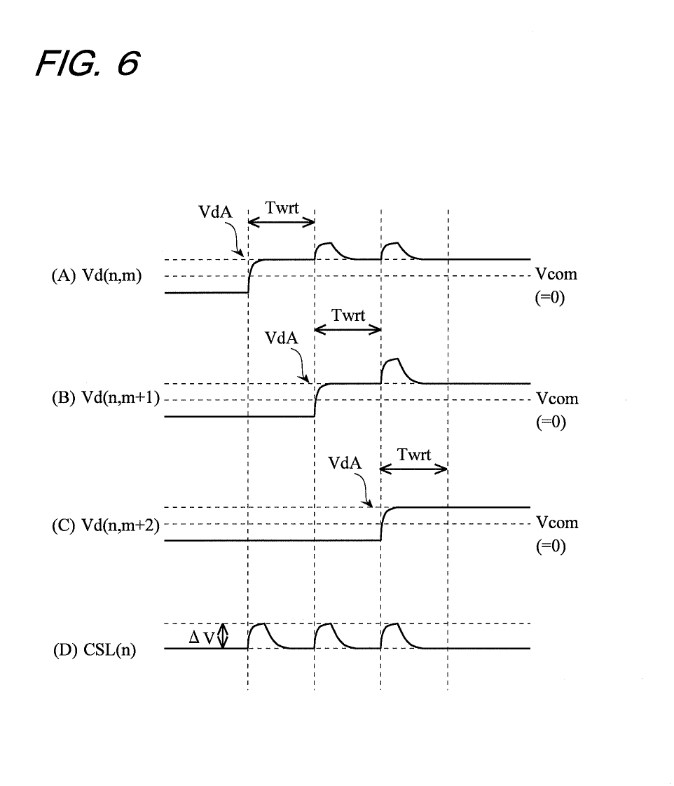

FIGS. 18(A) to 18(D) are voltage waveform charts of the pixel potentials Vd(n, m) to Vd(n, m+2) and the potential in the auxiliary capacitance line CSL(n) in FIG. 17, respectively. In the pixel potentials Vd(n, m) to Vd(n, m+2) illustrated in FIGS. 18(A) to 18(C), the influence of the potential fluctuation ΔV in the auxiliary capacitance line CSL(n) before the write period Twrt is omitted for convenience (also in FIGS. 6(A) to 6(C) which will be described later). In the potential in the auxiliary capacitance line CSL(n) illustrated in FIG. 18(D), the influence by the pixel potentials Vd(n, 1) to Vd(n, m−1) and Vd(n, m+3) to Vd(n, m) is omitted for convenience (also in FIG. 6(D) which will be described later). Since all of the pixels corresponding to the pixel potentials Vd(n, m) to Vd(n, m+2) are gray, the write potential of the pixel potentials Vd(n, m) to Vd(n, m+2) become the same VdA. Consequently, the amount ΔV of the potential fluctuation in the auxiliary capacitance line CSL(n) which occurs at the time of writing each of the pixel potentials is uniform. Therefore, no lateral crosstalk occurs in pixels corresponding to the scanning signal line GL(n) and the auxiliary capacitance line CSL(n).

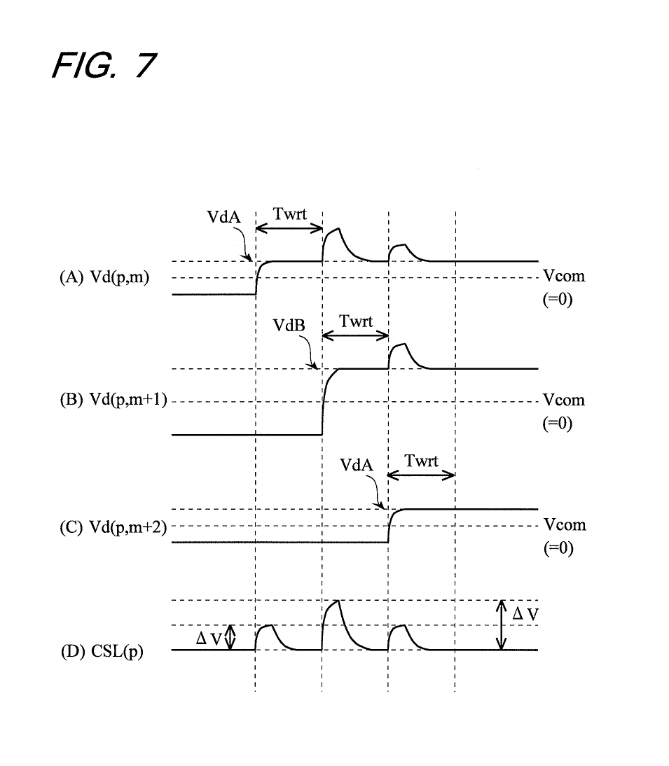

FIGS. 19(A) to 19(D) are voltage waveform charts of the pixel potentials Vd(p, m) to Vd(p, m+2) and the potential in the auxiliary capacitance line CSL(p) in FIG. 17, respectively. In the pixel potentials Vd(p, m) to Vd(p, m+2) illustrated in FIGS. 19(A) to 19(C), the influence of the potential fluctuation ΔV in the auxiliary capacitance line CSL(n) before the write period Twrt is omitted for convenience (also in FIGS. 7(A) to 7(C) which will be described later). In the potential in the auxiliary capacitance line CSL(p) illustrated in FIG. 19(D), the influence by the pixel potentials Vd(p, 1) to Vd(p, m−1) and Vd(p, m+3) to Vd(p, m) is omitted for convenience (also in FIG. 7(D) which will be described later). The pixels corresponding to the pixel potentials Vd(p, m) and Vd(p, m+2) are gray, and the pixels corresponding to the pixel potential Vd(p, m+1) are white. The write potential of Vd(p, m) and Vd(p, m+2) is VdA, and the write potential of the pixel potential Vd(p, m+1) is VdB(>VdA). Consequently, the amount ΔV of the potential fluctuation in the auxiliary capacitance line CSL(p) which occurs at the time of writing each of the pixel potentials Vd(p, m) and Vd(p, m+2) is small, and the amount ΔV of the potential fluctuation in the auxiliary capacitance line CSL(p) which occurs at the time of writing the pixel potential Vd(p, m+1) is large. In the case where the potential of the auxiliary capacitance potential CSL(p) which fluctuates largely at the time of writing the pixel potential Vd(p, m+1) does not recover to the original potential before completion of the writing of the pixel potential Vd(p, m+2), a deviation occurs in the potential of the auxiliary capacitance line CSL(p) at the start time of writing the pixel potential Vd(p, m+2) (in the figure, the solid lines indicate the potential in which the deviation occurs and the broken lines indicate ideal potentials). Due to the influence of the deviation in the potential of the auxiliary capacitance line CSL(p), the potential of the auxiliary capacitance CSL(p) does not recover to the original potential within the period of writing the pixel potential Vd(p, m+2), and the residual voltage ΔVcs is generated. As a result, the pixel potential Vd(p, m+2) becomes VdA−ΔVd which is the value different from the potential VdA to be held originally, and corresponding pixels become darker than gray which is to be displayed originally. The pixel potential Vd(p, m+1) corresponding to white display also becomes the value different from the potential VdB to be held originally and pixels become darker than the original color.

In the case of employing the configuration of the liquid crystal display device described in the Patent Document 4 to solve the above-described lateral crosstalk, as mentioned above, a comparison circuit, a detection circuit, and an output circuit are necessary for each of the auxiliary capacitance lines, so that the circuit configuration becomes complicated.

Embodiments of the present invention made by the present inventors based on the basic examination will be described hereinafter with reference to the appended drawings.

### 1. First Embodiment

<1.1 Configuration of Liquid Crystal Display Device>

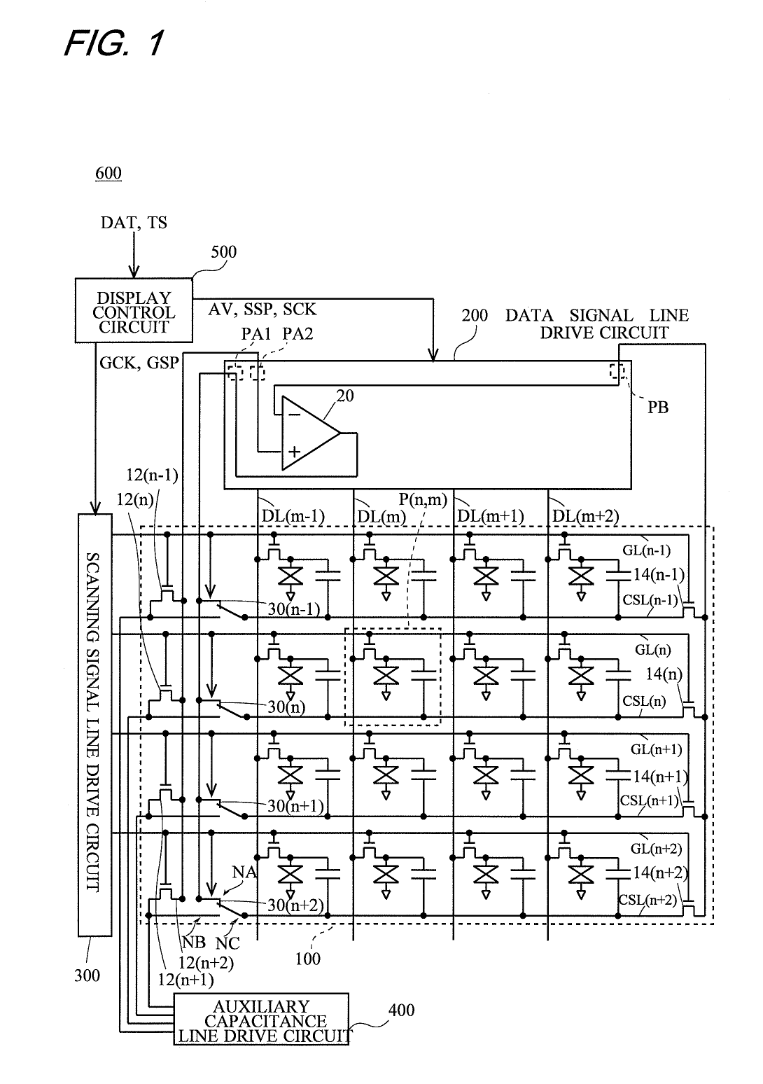

FIG. 1 is a circuit diagram illustrating an electrical configuration of a liquid crystal display device according to a first embodiment of the present invention. The same reference numerals are designated to the same elements as those of the conventional liquid crystal display device 690 in components of the embodiment and their description will not be repeated. As illustrated in FIG. 1, a liquid crystal display device 600 of the embodiment has a display panel 100, a data signal line drive circuit 200, the scanning signal line drive circuit 300, the auxiliary capacitance line drive circuit 400, and the display control circuit 500. Any or all of the data signal line drive circuit 200, the scanning signal line drive circuit 300, the auxiliary capacitance line drive circuit 400, and the display control circuit 500 are, for example, installed as ICs (Integrated Circuits) on the TFT substrate of the display panel 100. Any or all of the data signal line drive circuit 200, the scanning signal line drive circuit 300, and the auxiliary capacitance line drive circuit 400 may be formed integrally with the display panel 100.

<1.2 Configuration of Display Panel and Data Signal Line Drive Circuit>

The display panel 100 is obtained by adding, to the display panel 190 of the conventional liquid crystal display device 690, a plurality of change-over switches 30(1) to 30(N) provided in correspondence with the auxiliary capacitance lines CSL(1) to CSL(N), respectively (hereinbelow, called “change-over switches 30” when they are not distinguished from one another), input-end-side TFTs 12(1) to 12(N) as a plurality of input-end-side switching elements provided on the input end side (the left side in FIG. 1) of the auxiliary capacitance lines CSL(1) to CSL(N) (hereinbelow, called “input-end-side TFTs 12” when they are not distinguished from one another), and output-end-side TFTs 14(1) to 14(N) as a plurality of output-end-side switching elements provided on the output end side (right side in FIG. 1) of the auxiliary capacitance lines CSL(1) to CSL(N) (hereinbelow, called “output-end-side TFTs 14” when they are not distinguished from one another).

The data signal line drive circuit 200 is obtained by adding, to the data signal line drive circuit 290 of the conventional liquid crystal display device 690, an operational amplifier 20 as a differential amplifier having an inversion input terminal as a first input terminal, a non-inversion input terminal as a second input terminal, and an output terminal. Like the data signal line drive circuit 290 of the conventional liquid crystal display device 690, the data signal line drive circuit 200 receives the analog image signal AV, the data start pulse signal SSP, and the data clock signal SCK which are output from the display control circuit 500 and sequentially applies the analog image signal AV to the data signal lines DL based on the data start pulse signal SSP and the data clock signal SCK. That is, the data signal line drive circuit 200 performs driving by the dot-sequential driving method. The present invention is not limited to the dot-sequential driving method. The data signal line drive circuit 200 may perform driving by the so-called SSD method as a method of grouping the plurality of data signal lines DL to groups each made of predetermined number of data signal lines DL and driving each of the groups by time-sharing predetermined number of data signals corresponding to each of the groups by an output buffer common to the predetermined number of data signal lines DL. In this case, the data signal line drive circuit 200 receives a digital image signal DV in place of the analog image signal AV, serial-parallel converts the digital image signal DV, and performs digital-to-analog conversion to thereby generate a data signal.

Each of the change-over switches 30 has a switching terminal NA as a first switching terminal, a switching terminal NB as a second switching terminal, and a common terminal NC. Via the switching terminal NA and the common terminal NC in each change-over switch 30, the output terminal of the operational amplifier 20 included in the data signal line drive circuit 200 and the output terminal of the auxiliary capacitance line CSL corresponding to the change-over switch 30 are connected. Via the switching terminal NB and the common terminal NC in each change-over switch 30, the input terminal of the auxiliary capacitance line CSL corresponding to the change-over switch 30 and the auxiliary capacitance line drive circuit 400 are connected to each other. Each of the change-over switches 30 is controlled to select the switching terminal NA when the scanning signal line GL along the auxiliary capacitance line CSL corresponding to the change-over switch 30 is in the selection state, and to select the switching terminal NB when the scanning signal line GL is in the non-selection state. For example, the change-over switch 30(n) is controlled to select the switching terminal NA when the scanning signal line GL(n) along the auxiliary capacitance line CSL(n) corresponding to the change-over switch 30(n) is in the selection state and to select the switching terminal NB when the scanning signal line GL(n) is in the non-selection state.

The auxiliary capacitance line drive circuit 400 and the non-inversion input terminal of the operational amplifier 20 are connected to each other via each of the input-end-side TFTs 12. The source electrode as one of conduction terminals of each of the input-end-side TFTs 12 is connected to the auxiliary capacitance line drive circuit 400 and is also connected to the auxiliary capacitance line CSL corresponding to the input-end-side TFT 12 via the switching terminal NB and the common terminal NC. The drain electrode as the other one of the conduction terminals of each of the input-end-side TFTs 12 is connected to the non-inversion input terminal of the operational amplifier 20. The gate electrode as a control terminal of each of the input-end-side TFTs 12 is connected to the scanning signal line GL corresponding to the input-end-side TFT 12. Each of the input-end-side TFTs 12 is controlled to be in the conduction state when the scanning signal line GL corresponding to the input-end-side TFT 12 is in the selection state and to be in the blocked state when the scanning signal line GL is in the non-selection state. For example, the input-end-side TFT 12(n) is controlled to be in the conduction state when the scanning signal line GL(n) corresponding to the input-end-side TFT 12(n) is in the selection state and to be in the blocking state when the scanning signal line GL(n) is in the non-selection state.

Via an output-end-side TFT 14, the output end of the auxiliary capacitance line CSL corresponding to the output-end-side TFT 14 and the inversion input terminal of the operational amplifier 20 are connected to each other. The source electrode of the output-end-side TFT 14 is connected to the output end of the auxiliary capacitance line CSL corresponding to the output-end-side TFT 14, and the drain electrode is connected to the inversion input terminal of the operational amplifier 20. The gate electrode as a control terminal of each of the output-end-side TFTs 14 is connected to the scanning signal line GL corresponding to the output-end-side TFT 14. Each output-end-side TFT 14 is controlled to be in the conduction state when the scanning signal line GL corresponding to the output-end-side TFT 14 is in the selection state and to be in the blocking state when the scanning signal line GL is in the non-selection state. For example, an output-end-side TFT 14(n) is controlled to be in the conduction state when the scanning signal line GL(n) corresponding to the output-end-side TFT 14(n) is in the selection state and to be in the blocking state when the scanning signal line GL(n) is in the non-selection state.

The operational amplifier 20 applies again, to the auxiliary capacitance line CSL connected thereto via the switching terminal NB, an output signal which is output so that the voltage of an auxiliary capacitance signal (hereinbelow, called a “fluctuation auxiliary capacitance signal”) to be given to the inversion input terminal becomes equal to the voltage of the auxiliary capacitance signal (hereinbelow, called a “reference auxiliary capacitance signal”) to be given to the non-inversion input terminal. That is, the operational amplifier 20 receives, via the inversion input terminal, the fluctuation auxiliary capacitance signal which is output from the output end of the auxiliary capacitance line CSL(n) via the output-end-side TFT 14(n), receives, via the non-inversion input terminal, the reference auxiliary capacitance signal to be applied to the auxiliary capacitance line CSL(n) from the auxiliary capacitance line drive circuit 400 via the input-end-side TFT 12(n) and the change-over switch 30(n), and applies again an output signal which is output to make the voltage of the fluctuation auxiliary capacitance signal equal to the voltage of the reference auxiliary capacitance signal to the auxiliary capacitance line CSL(n). Therefore, by correcting the potential of the auxiliary capacitance line CSL(n) by feeding the fluctuation auxiliary capacitance signal as the potential of the auxiliary capacitance line CSL(n) in which the potential fluctuation occurs back to the operational amplifier 20 and applying again the output signal which is output to make the voltage of the fluctuation auxiliary capacitance signal equal to the voltage of the reference auxiliary capacitance signal as the potential to be originally given to the auxiliary capacitance line CSL(n), the potential fluctuation ΔV in the auxiliary capacitance line CSL(n) which occurs at the time of writing the data signal can be cancelled out.

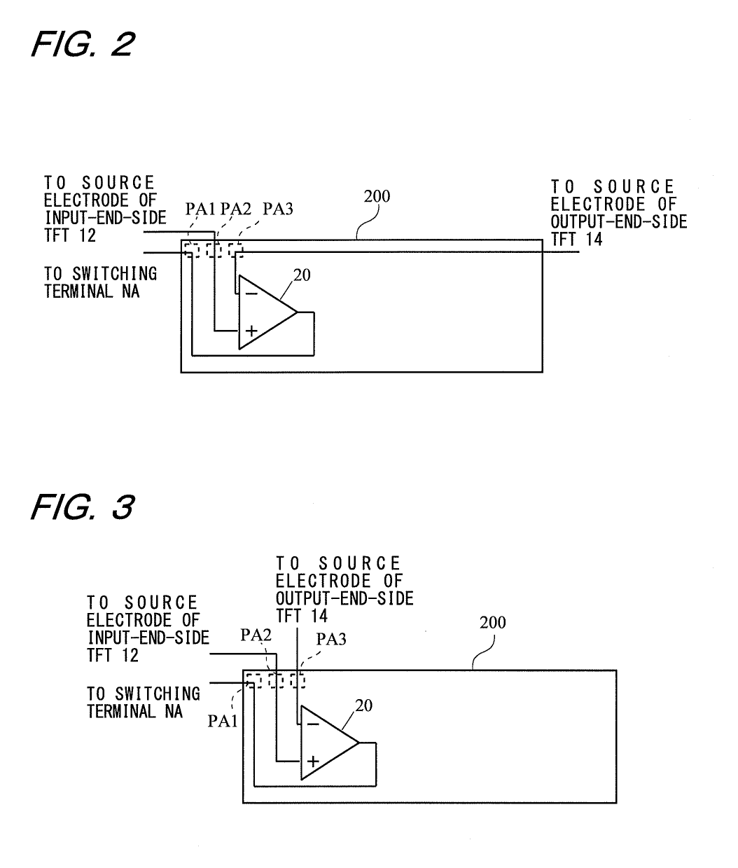

The operational amplifier 20 is provided in the data signal line drive circuit 200 to avoid crossing of the operational amplifier 20 and the data signal lines DL(1) to DL(M). Since the data signal line drive circuit 200 is realized by an IC as described above, connection to an external line is performed via a chip pad. As illustrated in FIG. 1, chip pads PA1 and PA2 are disposed near the left end on the side of receiving the analog image signal AV and the like of the data signal line drive circuit 200, and a chip pad PB is disposed near the right end. Also chip pads for connection to the display control circuit 500 and the like are also disposed in the data signal line drive circuit 200; however its illustration and description are omitted for convenience. The output terminal of the operational amplifier 20 and the switching terminal NA of each of the change-over switches 30 are connected by a wire via the chip pad PA1. The non-inversion input terminal of the operational amplifier 20 and the drain electrode of each of the input-end-side TFTs 12 are connected to each other by a wire via the chip pad PA2. The inversion input terminal of the operational amplifier 20 and the drain electrode of each of the output-end-side TFTs 14 are connected to each other by a wire via the chip pad PB. By the layout of the chip pads and the wiring connection as described above, the operational amplifier 20 provided in the data signal line drive circuit 200 can be connected to each of the components. The present invention is not limited to the layout of the chip pads and the wiring connection as described above but may employ layouts of chip pads and wiring connection like an example illustrated in FIG. 2 or FIG. 3.

In an example illustrated in FIG. 2, the chip pads PA1 to PA3 are disposed only at the left end on the side of receiving the analog image signal DV and the like of the data signal line drive circuit 200. The output terminal of the operational amplifier 20 and the switching terminal NA of each of the change-over switches 30 are connected to each other by a wire via the chip pad PA1. The non-inversion input terminal of the operational amplifier 20 and the drain electrode of each of the input-end-side TFT 12 are connected to each other by a wire via the chip pad PA2. The inversion input terminal of the operational amplifier 20 and the drain electrode of each of the output-end-side TFT 14 are connected to each other by a wire via the chip pad PA3. The wire from the drain electrode of each of the output-end-side TFTs 14 passes through the space between the data signal line drive circuit 200 and the display panel 100 on which the data signal line drive circuit 200 is mounted and is connected to the chip pad PA3.

An example illustrated in FIG. 3 is similar to that illustrated in FIG. 2 except for the place where the wire from the drain electrode of each of the output-end-side TFTs 14 passes. Specifically, the wire from the drain electrode of each of the output-end-side TFTs 14 passes in the outer periphery of the display panel 100 and is connected to the chip pad PA. To pass the wire in the outer periphery of the display panel 100 as described above, for example, a flexible printed board or the like can be used.

The operational amplifier 20 may not be formed in the data signal line drive circuit 200 but may be formed on the outside of the data signal line drive circuit 200 integrally with the display panel 100. In the case of using the power supply of the scanning signal line drive circuit 300 as the power supply of the operational amplifier 20, preferably, the operational amplifier 20 is provided near the scanning signal line drive circuit 300. Further, in the case where the data signal line drive circuit 200 is formed integrally with the display panel 100, preferably, the operational amplifier 20 is formed integrally with the display panel 100 in a position opposed to the position where the data signal line drive circuit 200 is formed while sandwiching the scanning signal lines GL(1) to GL(N) and the like.

<1.3 Operation>

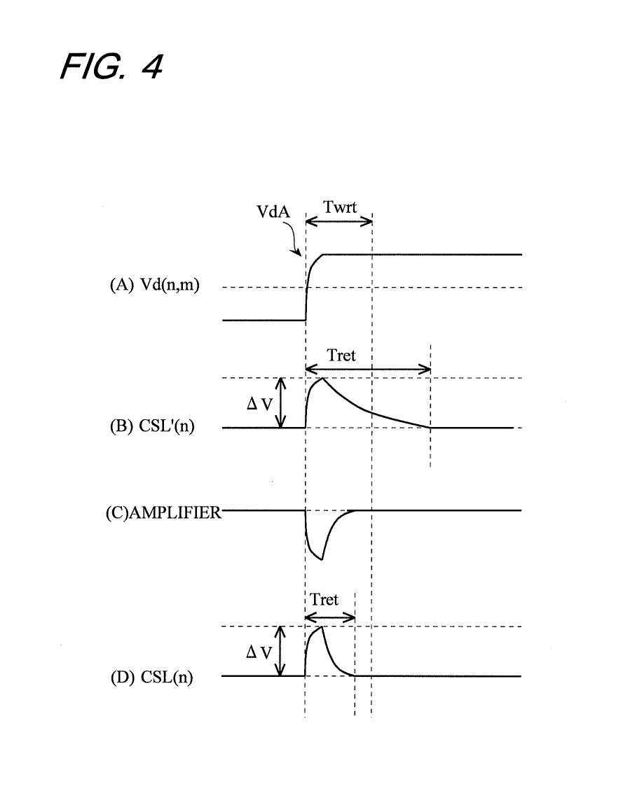

With reference to FIGS. 12(A) to 12(E) and FIGS. 4(A) to 4(D), the operation of the liquid crystal display device 600 according to the embodiment will be described. Since FIGS. 12(A) to 12(E) have been described in the basic examination, description of parts common to the embodiment will be properly omitted.

FIGS. 4(A) to 4(D) are voltage waveform charts of the pixel potential Vd(n, m) in the embodiment resulting from enlarging the part RB surrounded by the broken line in FIG. 12(E), the potential of the auxiliary capacitance line CSL′ (n) in the conventional liquid crystal display device resulting from enlarging the part RB surrounded by the broken line in FIG. 12(C), an output signal which is output from the operational amplifier 20, and the potential of the auxiliary capacitance line CSL(n) in the embodiment resulting from enlarging the part RA surrounded by the broken line in FIG. 12(C).

In the first frame period TF1, when the scanning signal line GL(n) is in the selection state (FIG. 12(A)), the pixel TFTs 101 in the pixel circuits P(n, 1) to P(n, M) connected to the scanning signal line GL(n) become conductive. At this time, the input-end-side TFT 12(n) and the output-end-side TFT 14(n) become conductive, and the change-over switch 30(n) selects the switching terminal NA. Consequently, a fluctuation auxiliary capacitance signal which is output from the output end of the auxiliary capacitance line CSL(n) via the output-end-side TFT 14(n) is given to the inversion input terminal of the operational amplifier 20, and a reference auxiliary capacitance signal to be applied from the auxiliary capacitance line drive circuit 400 to the auxiliary capacitance line CSL(n) via the input-end-side TFT 12(n) and the change-over switch 30(n) is given to the non-inversion input terminal of the operational amplifier 20. The operational amplifier 20 generates an output signal to be output to make the voltage of the fluctuation auxiliary capacitance signal equal to the voltage of the reference auxiliary capacitance signal, and applies again the output signal to the auxiliary capacitance line CSL(n) via the switching terminal NA and the common terminal NC of the change-over switch 30(n). That is, when the scanning signal line GL(n) is in the selection state, to the auxiliary capacitance line CSL(n), the auxiliary capacitance signal from the auxiliary capacitance line drive circuit 400 is not applied but the output signal from the operational amplifier 20 is applied (FIG. 4(C)). The output signal changes in a manner opposite to the potential fluctuation which occurs in the auxiliary capacitance line CSL(n). By application of the output signal to the auxiliary capacitance line CSL(n), the potential fluctuation in the auxiliary capacitance line CSL(n) is canceled out. Therefore, the recovery time Tret of the potential fluctuation in the auxiliary capacitance line CSL(n) becomes shorter than the recovery time Tret of the potential fluctuation in the auxiliary capacitance line CSL′ (n) of the conventional liquid crystal display device (FIG. 4(D)). Consequently, Twrt>Tret is satisfied, so that the residual voltage ΔVcs caused when the potential of the auxiliary capacitance line CSL(n) does not recover within the period Twrt of writing the pixel potential Vd(n, m) is not generated. As a result, the pixel potential Vd(n, m) is held at the potential VdA to be held originally (FIG. 4(A)).

When attention is paid to the scanning signal line GL(n+1) in a non-selection state, the input-end-side TFT 12(n+1) and the output-end-side TFT 14(n+1) are in the blocking state, and the change-over switch 30(n+1) selects the switching terminal NB. Consequently, to the auxiliary capacitance line CSL(n+1) corresponding to the scanning signal line GL(n+1), an output signal from the operational amplifier 20 is not applied but the reference auxiliary capacitance signal is applied from the auxiliary capacitance line drive circuit 400 via the switching terminal NB and the common terminal NC. At this time, the auxiliary capacitance line CSL(n+1) corresponding to the scanning signal line GL(n+1) which is in the non-selection state is not influenced by the fluctuation auxiliary capacitance signal which is output from the output end of the auxiliary capacitance line CSL(n) corresponding to the scanning signal line GL(n) which is in the selection state. That is, a correction for the potential fluctuation is performed only for the auxiliary capacitance line CSL(n) corresponding to the scanning signal line GL(n) which is in the selection state. A correction for the potential fluctuation is not performed but the conventional driving is performed for the auxiliary capacitance line CSL(n+1) corresponding to the scanning signal line GL(n+1) which is in the non-selection state.

With reference to FIGS. 5 to 7, a state where the lateral crosstalk is suppressed in the embodiment will be described. FIG. 5 is a diagram illustrating a state where a display pattern similar to the display pattern made by the gray background part and the white center part illustrated in FIG. 17 is displayed in the embodiment. In FIG. 5, the gray background part is hatched. In FIG. 5, for convenience of explanation, the sizes of pixels are not uniform. Further, the downward arrow and the rightward arrow in FIG. 5 express the vertical scanning direction and the horizontal scanning direction, respectively, in the image display.

FIGS. 6(A) to 6(D) are voltage waveform charts of the pixel potentials Vd(n, m) to Vd(n, m+2) and the potential of the auxiliary capacitance line CSL(n) in FIG. 5, respectively. Since all of the pixels corresponding to the pixel potentials Vd(n,m) to Vd(n, m+2) are gray, the write potential of the pixel potentials Vd(n, m) to Vd(n, m+2) become the same VdA. Consequently, the amount of the potential fluctuation in the auxiliary capacitance line CSL(n) which occurs at the time of writing each of the pixel potentials is uniform. Therefore, no lateral crosstalk occurs in pixels corresponding to the scanning signal line GL(n) and the auxiliary capacitance line CSL(n). As described above, in the case where pixels of the same color (gray) continue, display is similar to that of the conventional liquid crystal display device.

FIGS. 7(A) to 7(D) are voltage waveform charts of the pixel potentials Vd(p, m) to Vd(p, m+2) and the potential in the auxiliary capacitance line CSL(p) in FIG. 5, respectively. The pixels corresponding to the pixel potentials Vd(p, m) and Vd(p, m+2) are gray, and the pixels corresponding to the pixel potential Vd(p, m+1) are white. The write potential of Vd(p, m) and Vd(p, m+2) is VdA, and the write potential of the pixel potential Vd(p, m+1) is VdB (>VdA). Consequently, the amount ΔV of the potential fluctuation in the auxiliary capacitance line CSL (p) which occurs at the time of writing each of the pixel potentials Vd(p, m) and Vd(p, m+2) is small, and the amount ΔV of the potential fluctuation in the auxiliary capacitance line CSL(p) which occurs at the time of writing the pixel potential Vd(p, m+1) is large. In the embodiment, however, the potential fluctuation is corrected by the output signal from the operational amplifier 20. Consequently, different from the conventional liquid crystal display device 690 described in the basic examination, even when the potential of the auxiliary capacitance CSL(p) fluctuates largely at the time of writing the potential Vd(p, m+1), the fluctuated potential recovers to the original potential before writing of the pixel potential Vd(p, m+2), and no deviation occurs in the potential of the auxiliary capacitance line CSL(p) at the start time of writing the pixel potential Vd (p, m+2). Therefore, since the potential fluctuation in the auxiliary capacitance line CSL(p) which occurs at the time of writing the pixel potential Vd(p, m+2) is also solved in the write period, the residual voltage ΔVcs is not generated. As a result, the pixel potential Vd(p, m+2) is held at the original write potential VdA, so that pixels corresponding to the pixel potential Vd(p, m+2) become gray similar to the color to be originally displayed and does not become darker. As described above, in the display pattern displayed by the liquid crystal display device 600 according to the embodiment, different from the display pattern displayed by the conventional liquid crystal display device, no lateral crosstalk occurs.

<1.4 Effects>

In the embodiment, the potential of the auxiliary capacitance line is corrected by the output signal from the operational amplifier 20. Therefore, the time Tret until the potential of the auxiliary capacitance line which fluctuates at the time of writing a data signal recovers to the original potential becomes shorter than that in the conventional technique, so that a fluctuation in the pixel potential caused by the potential fluctuation in the auxiliary capacitance line does not occur. In addition, one operational amplifier 20 is sufficient. Thus, a lateral crosstalk can be suppressed with the simple configuration.

In the embodiment, since the input-end-side TFT 12 is provided, in the case where there are three or more kinds of potentials applied to the auxiliary capacitance line CSL, it is unnecessary to provide special design to the auxiliary capacitance line drive circuit 400. Further, in the embodiment, the input-end-side TFT 12, the change-over switch 30, and the output-end-side TFT 14 are controlled by the potential (scanning signal) of the scanning signal line GL. Therefore, correction is performed only for the auxiliary capacitance line in which a potential fluctuation occurs and, further, it is unnecessary to separately use a signal for controlling the input-end-side TFT 12, the change-over switch 30, and the output-end-side TFT 14. Therefore, a lateral crosstalk can be efficiently suppressed with the simple configuration.

### 2. Second Embodiment

<2.1 Configuration of Liquid Crystal Display Device>

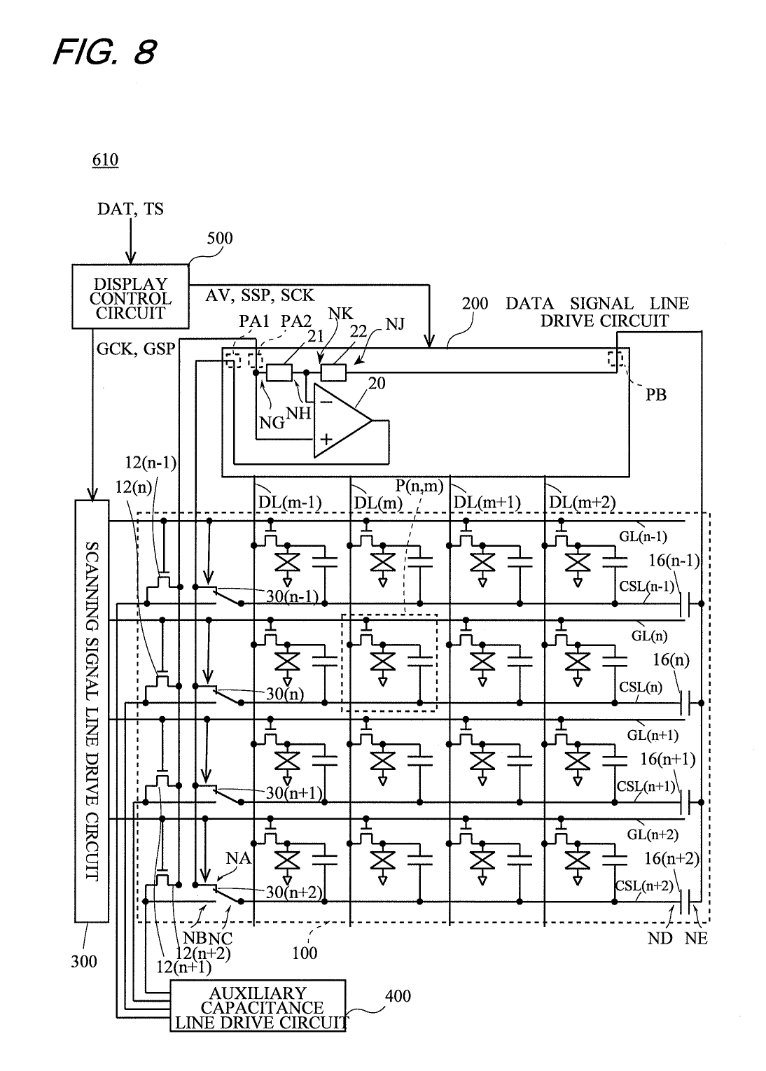

FIG. 8 is a circuit diagram illustrating an electrical configuration of a liquid crystal display device 610 according to a second embodiment of the present invention. The liquid crystal display device 610 of the embodiment has a configuration similar to that of the liquid crystal display device 600 of the first embodiment except for having capacitors 16(1) to 16(N) as capacitive elements (hereinbelow, called “capacitors 16” when they are not distinguished from one another) in place of the output-end-side TFTs 14 and having a first resistive element 21 and a second resistive element 22. The same reference numerals are designated to the same components as those of the first embodiment in the components of the embodiment and their description will not be repeated.

As illustrated in FIG. 8, the display panel 100 in the embodiment has, in place of the output-end-side TFTs 14, the plurality of capacitors 16(1) to 16(N) respectively provided on the output-end-side (right side in FIG. 8) of the auxiliary capacitance lines CSL(1) to CSL(N). The data signal line drive circuit 200 in the embodiment further has the first and second resistive elements 21 and 22. The resistance value of the first resistive element 21 is larger than that of the second resistive element 22.

The drain electrode of each of the input-end-side TFTs 12 is connected to the non-inversion input terminal of the operational amplifier 20 and is also connected to a terminal NG as one end of the first resistive element 21. A terminal

ND as one end of each of the capacitors 16 is connected to the output end of the corresponding auxiliary capacitance line CSL, and the terminal NE as the other end is connected to a terminal NJ as one end of the second resistive element 22. A terminal NH as the other end of the first resistive element 21 and NK as the other end of the second resistive element 22 are connected to each other and are also connected to the inversion input terminal of the operational amplifier 20.

To the inversion input terminal of the operational amplifier 20, an auxiliary capacitance signal to be applied to the auxiliary capacitance line CSL disposed along the scanning signal line GL which is in the selection state is provided via the first resistive element 21 and an auxiliary capacitance signal which is output from the output end of the auxiliary capacitance line CSL is provided via the capacitor 16 connected to the output end of the auxiliary capacitance line CSL and the second resistive element 22. That is, the fluctuation auxiliary capacitance signal in the embodiment is the sum of a signal obtained by attenuating a signal having the same potential as the reference auxiliary capacitance signal by the first resistive element 21 and a signal obtained by attenuating a signal as a high frequency component of the auxiliary capacitance signal output from the output end of the auxiliary capacitance line CSL by the second resistive element 22.

<2.2 Effect>

In the embodiment, in a manner similar to the first embodiment, the potential of the auxiliary capacitance line is corrected by the output signal from the operational amplifier 20. Therefore, a lateral crosstalk can be suppressed with a simpler configuration.

The second resistive element 22 may not be provided. In place of the second resistive element, a resistive element may be provided on the terminal NE side of each of the capacitors 16 (between each capacitor 16 and the chip pad PB).

### 3. Third Embodiment

<3.1 Configuration of Liquid Crystal Display Device>

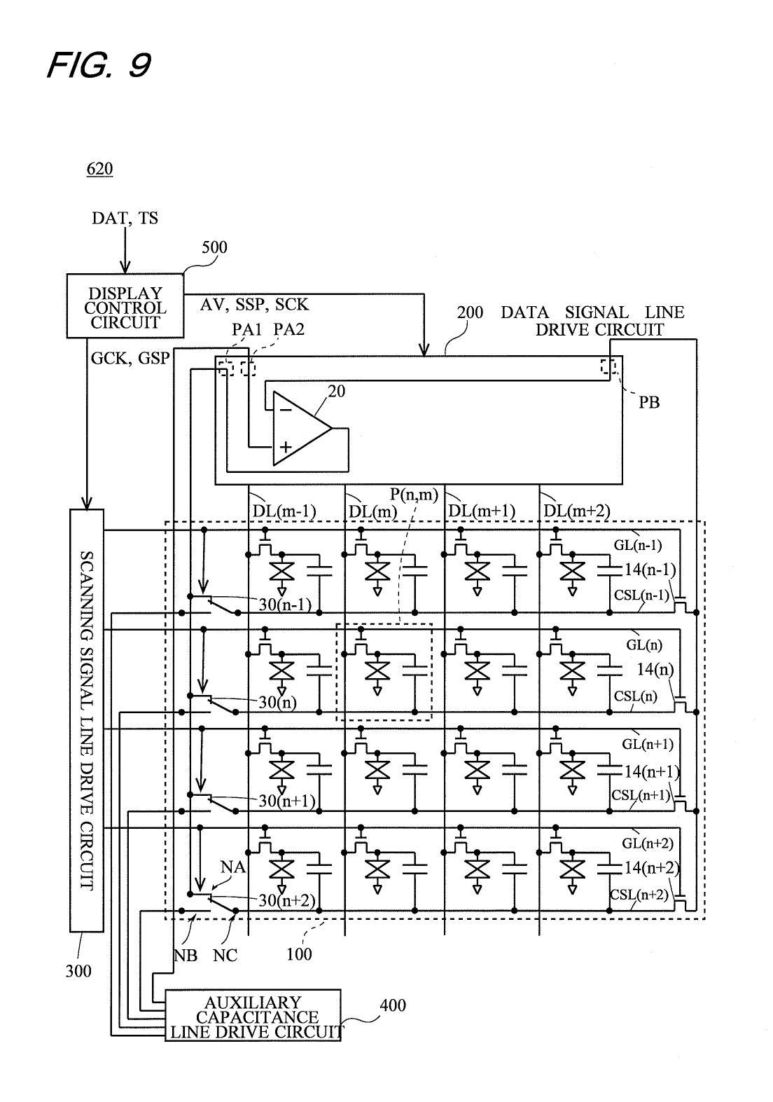

FIG. 9 is a circuit diagram illustrating an electrical configuration of a liquid crystal display device 620 according to a third embodiment of the present invention. The liquid crystal display device 620 of the embodiment has a configuration similar to that of the liquid crystal display device 600 of the first embodiment except for having an auxiliary capacitance line drive circuit 410 in place of the auxiliary capacitance line drive circuit 400 and having no input-end-side TFTs 12. The same reference numerals are designated to the same components as those of the first embodiment in the components of the embodiment and their description will not be repeated.

As illustrated in FIG. 9, the display panel 100 in the embodiment does not have the input-end-side TFT 12. That is, the auxiliary capacitance line drive circuit 410 and the non-inversion input terminal of the operational amplifier 20 are connected to each other directly.

The auxiliary capacitance line drive circuit 410 applies a predetermined low potential VL and a predetermined high potential VH as reference potentials of a voltage to be applied to the liquid crystal layer in the display panel 100 to a plurality of auxiliary capacitance lines CSL(1) to CSL(N). A selection switch (not illustrated) is provided in the auxiliary capacitance line drive circuit 410. The selection switch is controlled to select a potential to be applied to the non-inversion input terminal of the operational amplifier 20 from the low potential VH and the high potential VH. More specifically, in the case where the scanning signal line GL(n) is in the selection state, the selection switch is controlled to give the same potential as the potential to be applied to the corresponding auxiliary capacitance line CSL(n) to the non-inversion input terminal of the operational amplifier 20.

<3.2 Effect>

In the embodiment, in a manner similar to the first embodiment, the potential of the auxiliary capacitance line is corrected by the output signal from the operational amplifier 20. Therefore, a lateral crosstalk can be suppressed with a simpler configuration.

<4. Others>

In the foregoing first embodiment, the input-end-side TFT 12, the change-over switch 30, and the output-end-side TFT 14 are controlled by the potential of the scanning signal line. The present invention is not limited to the first embodiment but they may be controlled by another signal. In this case, it is desirable to control the switching of the switching terminal of the change-over switch 30 prior to the switching of the states of the input-end-side TFT 12 and the output-end-side TFT 14.

In the third embodiment, two kinds of potentials of the low potential VH and the high potential VH are used as potentials applied to the auxiliary capacitance line. However, three or more kinds (though the number is preferably smaller than the number of scanning signal lines GL) may be used. In this case, in place of the selection switch, a selection switch controlled to select a potential to be provided to the non-inversion input terminal of the operational amplifier 20 from any of the three kinds of potentials is used. Except for the selection switch, also by a computation processor and a D/A converter or the like, operation similar to that of the auxiliary capacitance line drive circuit 410 can be realized. In this case, the computation processor generates a digital signal corresponding to the potential to be given to the non-inversion input terminal of the operational amplifier 20 based on the digital signal which is output from the display control circuit 500, and the D/A converter generates a potential to be given to the non-inversion input terminal of the operational amplifier 20 as an analog signal based on the digital signal generated by the computation processor.

In place of the operational amplifier 20 in each of the foregoing embodiments, another differential amplifier may be used.

Although the example of performing display in the normally black mode is employed in the foregoing embodiment, also in the case of performing display in a normally white mode, effects similar to those of each of the foregoing embodiments can be obtained.

The present invention can be variously modified and executed without departing from the gist of the present invention.

As described above, the present invention can provide a display device in which a lateral crosstalk can be suppressed with a simple configuration.

### INDUSTRIAL APPLICABILITY

The present invention can be applied to an active matrix-type display device using a switching element such as a thin film transistor.

### DESCRIPTION OF REFERENCE CHARACTERS

12(1) to 12(N): INPUT-END-SIDE TFT (INPUT-END-SIDE SWITCHING ELEMENT)

14(1) to 14(N): OUTPUT-END-SIDE TFT (OUTPUT-END-SIDE SWITCHING ELEMENT)

16(1) to 16(N): CAPACITOR (CAPACITIVE ELEMENT)

20: OPERATIONAL AMPLIFIER (DIFFERENTIAL AMPLIFIER)

21: FIRST RESISTIVE ELEMENT

22: SECOND RESISTIVE ELEMENT

30(1) to 30(N): CHANGE-OVER SWITCH

100, 190: DISPLAY PANEL

101: PIXEL TFT (PIXEL SWITCHING ELEMENT)

200, 290: DATA SIGNAL LINE DRIVE CIRCUIT

300: SCANNING SIGNAL LINE DRIVE CIRCUIT

400, 410: AUXILIARY CAPACITANCE LINE DRIVE CIRCUIT

500: DISPLAY CONTROL CIRCUIT

600, 610, 620, 690: LIQUID CRYSTAL DISPLAY DEVICE

CSL(1) to CSL(N): AUXILIARY CAPACITANCE LINE

DL(1) to DL(M): DATA SIGNAL LINE

GL(1) to GL(N): SCANNING SIGNAL LINE

1. A display device comprising:
a plurality of data signal lines to which a plurality of data signals representing an image to be displayed are applied, respectively;
scanning signal lines crossing the plurality of data signal lines and selectively driven by applying a plurality of scanning signals, respectively;
a plurality of pixel circuits disposed in a matrix in correspondence with respective intersections of the plurality of data signal lines and the plurality of scanning signal lines;
a plurality of auxiliary capacitance lines disposed along the plurality of scanning signal lines, respectively;
an auxiliary capacitance line drive circuit for applying a plurality of auxiliary capacitance signals to the plurality of auxiliary capacitance lines, respectively;
a differential amplifier including a first input terminal, a second input terminal, and an output terminal; and
a plurality of change-over switches provided in correspondence with the plurality of auxiliary capacitance lines, respectively,
wherein each of the change-over switches includes a first switching terminal and a second switching terminal,
each of the pixel circuits includes
a pixel switching element which enters a conduction state when the scanning signal line passing a corresponding intersection is in a selection state and enters a blocking state when the scanning signal line is in a non-selection state,
a pixel electrode connected to a data signal line passing the corresponding intersection via the pixel switching element,
a common electrode provided commonly to the plurality of pixel circuits, and
an auxiliary capacitance formed between the pixel electrode and an auxiliary capacitance line disposed along a scanning signal line passing the corresponding intersection,
after the scanning signal line is switched from a selection state to a non-selection state, the auxiliary capacitance line drive circuit changes a potential of an auxiliary capacitance signal to be applied to an auxiliary capacitance line disposed along the scanning signal line,
the first input terminal and an output end of each of the auxiliary capacitance lines are connected to each other via a plurality of terminating end parts,
an auxiliary capacitance signal to be applied to the auxiliary capacitance line disposed along the scanning signal line which is in the selection state is given to the second input terminal from the auxiliary capacitance line drive circuit,
the output terminal and an input end of each of the auxiliary capacitance lines are connected to each other via the first switching terminal of a corresponding change-over switch,
the auxiliary capacitance line drive circuit and an input end of each of the auxiliary capacitance lines are connected to each other via the second switching terminal of a corresponding change-over switch, and
each of the change-over switches is controlled to select the first switching terminal or the second switching terminal in accordance with a predetermined signal.

2. The display device according to claim 1, wherein each of the change-over switches is controlled to select the first switching terminal when a scanning signal line along a corresponding auxiliary capacitance line is in a selection state and to select the second switching terminal when the scanning signal line is in a non-selection state.

3. The display device according to claim 2, wherein the auxiliary capacitance line drive circuit and the second input terminal are connected to each other via a plurality of input-end-side switching elements provided in correspondence with the plurality of auxiliary capacitance lines,
one of conduction terminals of each of the input-end-side switching elements is connected to the auxiliary capacitance line drive circuit and connected to a corresponding auxiliary capacitance line via the second switching terminal, and
the other conductive terminal of each of the input-end-side switching elements is connected to the second input terminal.

4. The display device according to claim 3, wherein a control terminal of each of the input-end-side switching elements is connected to a corresponding scanning signal line, and
each of the input-end-side switching elements enters a conduction state when the corresponding scanning signal line is in the selection state and enters a blocking state when the corresponding scanning signal line is in the non-selection state.

5. The display device according to claim 2, wherein each of the terminating end parts is an output-end-side switching element.

6. The display device according to claim 5, wherein a control terminal of each of the output-end-side switching elements is connected to a corresponding scanning signal line, and
each of the output-end-side switching elements enters a conduction state when the corresponding scanning signal line is in the selection state and enters a blocking state when the corresponding scanning signal line is in the non-selection state.

7. The display device according to claim 2, further comprising a first resistive element,
wherein each of the terminating end parts is a capacitive element, and
to the first input terminal, an auxiliary capacitance signal to be applied to an auxiliary capacitance line disposed along a scanning signal line which is in the selection state is given via the first resistive element, and an auxiliary capacitance signal output from an output end of the auxiliary capacitance line is given via a capacitive element connected to the output end of the auxiliary capacitance line.

8. The display device according to claim 7, further comprising a second resistive element,
wherein, to the first input terminal, an auxiliary capacitance signal to be applied to an auxiliary capacitance line disposed along a scanning signal line which is in the selection state is given via the first resistive element, and an auxiliary capacitance signal output from an output end of the auxiliary capacitance line is given via a capacitive element and the second resistive element connected to the output end of the auxiliary capacitance line.

9. The display device according to claim 2, wherein the auxiliary capacitance line drive circuit and the second input terminal are directly connected to each other and,
to the second input terminal, a signal having the same potential as that of an auxiliary capacitance signal to be applied to an auxiliary capacitance line disposed along a scanning signal line which is in the selection state is given.
